(19) United States
(12) Patent Application Publication
(10) Pub. No.: US 2016/0192700 A1
(43) Pub. Date: Jul. 7, 2016

(54) CATALYTICALLY DEGRADABLE PLASTIC AND USE OF SAME

(71) Applicant: SOLVAY ACETOW GMBH, Freiburg (DE)

(72) Inventors: Dirk HÖLTER, Emmendingen (DE); Wolfgang KOPPE, Merzhausen (DE)

(21) Appl. No.: 14/911,546

(22) PCT Filed: Jul. 30, 2014
(86) PCT No.: PCT/EP2014/066401

§ 371 Date: Feb. 11, 2016

(30) Foreign Application Priority Data
Aug. 12, 2013 (EP) 13180137.5

(51) Int. Cl. A24D 3/06; B01J 23/745; A24D 3/16; B01J 35/10; A24D 3/10; C08K 9/02; B01J 35/00

(52) U.S. Cl. CPC A24D 3/068; C08K 9/02; B01J 23/745; B01J 35/004; B01J 35/1019; B01J 35/1023; B01J 35/1028; B01J 35/0026; A24D 3/10; A24D 3/16

(57) ABSTRACT

A catalytically degradable plastic is described, with content of cellulose esters and also optionally of additives. A particular characterizing feature of this catalytically degradable plastic is that it contains a dispersed, catalytically active transition-metal-modified titanium dioxide.

The invention relates to a catalytically degradable plastics material, in particular having a content of cellulose esters, and to the use thereof, in particular in filter tows for producing filter plugs for filter cigarettes. This application claims priority to EP application no. 13180137.5, the entire content of which is hereby incorporated by reference for all purposes.

Plastics materials which end up or may end up in the environment at the end of their life cycle should be degradable under the conditions there prevailing within short periods of time in order to minimize any contamination. However even for plastics materials that are in principle biologically degradable the time required for their decomposition is highly dependent on external conditions. Thus, degradation under composting conditions is faster than in soils likewise containing microorganisms. Biodegradation is markedly slower when the conditions for the microorganisms required therefor are inadequate. This is the case when the relevant plastics material is lying completely or partly on a surface, for example paving slabs, asphalt, sand, earth or grass. When this is the case, other or additional degradation mechanisms are necessary. In these cases photocatalytic decomposition under the action of light is particularly suitable. This may be the sole mechanism for complete degradation of the material or else it may support other degradation mechanisms.

It has long been known that titanium dioxide, in particular in the anatase modification, can decompose organic materials by photocatalytic action. Anatase absorbs light in the ultraviolet range of the spectrum, the subsequent electron transfer processes affording free radicals which initiate chain-reaction mediated degradation.

As a result of increased public focus in the 1990s on the persistence of plastics materials once they have fulfilled their intended use, efforts toward degradation in the environment of cellulose esters and filter tow produced therefrom have been increased.

The applicant has previously provided satisfactory solutions for photocatalytic degradation of polymeric cellulose esters (see, for example, WO-A-2010/017989) in which the degradability is enhanced by carbon-modified titanium dioxide.

Departing from the previously described state of the art, the object of the present invention was to find further plastics materials catalytically degradable under environmental conditions. The invention further aims for this catalytically degradable plastics material to find advantageous application as moldings, in particular in a filter tow for producing a filter plug for a cigarette filter.

This object is achieved in accordance with the invention by a catalytically degradable plastics material of the type described at the outset when the catalytically degradable plastics material comprises a catalytically active transition-metal-modified titanium dioxide, in particular in finely divided form, for example dispersed, in the plastics material.

In the context of the present invention “transition-metal-modified” is to be understood as meaning in particular that the titanium dioxide has been altered by addition (for example mixing, impregnating, co-precipitating, co-crystallizing) of metals, metal compounds or metal complexes of the transition metals. “Transition metals” are metals of the groups 3 to 12 of the Periodic Table (IUPAC, 2013) with the exception of titanium, for example chromium, cobalt, copper, nickel, silver, gold, vanadium, zirconium, tungsten, molybdenum, tantalum, niobium, manganese, zinc and iron. Preference is given to non-toxic or low-toxicity transition metals, in particular manganese, zinc and iron. Iron is very particularly preferred. Especially suitable iron-modified titanium oxides comprising iron(III) oxide are disclosed in WO-A-2012/139726 the content of which is hereby fully incorporated into the present application by reference.

Surprisingly, modification of the titanium dioxide with transition metals results in an improvement of the catalytic activity toward decomposition of plastics materials without substantial detriment to the performance characteristics of the plastics material products.

When the plastics material is a cellulose ester, particular preference is given to cellulose acetate, cellulose propionate, cellulose butyrate, cellulose acetate propionate and/or cellulose acetate butyrate. The average degree of substitution (DS) is preferably between 1.5 and 3.0, in particular between 2.2 to 2.7, this being the case for cellulose acetate in particular. It is expedient when the average degree of polymerization of the cellulose ester, in particular cellulose acetate, is optimized for advantageous achievement of the stated object. The optimal average degree of polymerization for the cellulose ester is between 150 and 500, in particular between 180 and 280.

The plastics materials according to the invention, in particular cellulose ester compositions, undergo rapid catalytic degradation in the environment. As is shown by the following examples one suitable parameter is the reduction in mass of the catalytically degradable plastics material over time. Thus, the core of the invention is in the choice of a transition-metal-modified titanium dioxide that is transition-metal-modified on its surface or else throughout its entire volume. Preference is given to a transition-metal-modified titanium dioxide, the surface of which is transition-metal-doped. Doping reduces the bandgap of the semiconductor titanium dioxide and, compared to undoped titanium dioxide, also allows longer wavelength light to be utilized for exciting a valence band electron and thus for activating the photocatalytic properties.

The crystallite size of the transition-metal-doped titanium dioxide is advantageously optimized, the crystallite size thus preferably being between 5 and 150 nm, in particular between 7 to 25 nm. In certain cases it may be advantageous or even necessary to grind a coarsely divided transition-metal-modified titanium dioxide to achieve the optimal particle size. The transition-metal-modified titanium dioxide advantageously has a density (ISO 787, part 10) of 3.0 to 5.0 g/cm³, in particular of 3.5 to 4.2 g/cm³. Optimization of the specific surface area of the transition-metal-modified titanium dioxide is also advantageous for the degradation of the cellulose-ester-containing plastics material. The BET specific surface area of the transition-metal-doped titanium dioxide is preferably greater than 100 m²/g, in particular greater than 250 m²/g. The inclusion of a transition-metal-modified titanium dioxide in the catalytically degradable plastics material according to the invention is particularly advantageous when the transition-metal-modified titanium dioxide is characterized by enhanced light absorption in the range λ≧400 nm compared to pure titanium dioxide.

To further improve the catalytic degradability of the plastics material according to the invention it is advantageous to establish a transition-metal-modified titanium dioxide content therein of 0.1 to 5 wt %, in particular 0.3 to 1.5 wt %.

The transition metal content of the transition-metal-modified titanium dioxide is not substantially restricted. The transition-metal-modified titanium dioxide preferably comprises transition metal in an amount of from 0.05 to 5 wt %, in particular from 0.3 to 3 wt %.

It is possible in accordance with the invention for the catalytically degradable plastics material to be substantially not based solely on cellulose esters. In the case of employment in fibers of cigarette filter materials customary additives such as, for example, plasticizer may be included.

A non-transition-metal-modified titanium dioxide, in particular anatase, may also be included in finely dispersed form, this being the case particularly for applications relating to the cigarette industry. In order to adhere to the concept of the invention to the greatest possible extent and to utilize the particular photocatalytic activity of the transition-metal-modified titanium dioxide for degradation of a plastics material it is preferable when the cellulose ester content of the catalytically degradable plastics material accounts for at least 60 wt %, in particular at least 90 wt %.

The good catalytic degradability of the plastics material according to the invention is apparent particularly when the catalytically degradable plastics material is converted into a molding, in particular into fibers, films, in particular deep drawn films, especially for use as packaging materials, injection-molded articles, thick-walled moldings, pellets, beads, microbeads and vessels. These fibers are thus particularly advantageously further processed into filter tows from which filter rods and in turn filter plugs for filter cigarettes are produced. Such filter plugs present in the environment undergo degradation that is markedly faster than that of filter plugs not comprising modified titanium dioxide.

It is finally also noted that the process for producing the catalytically degradable plastics material according to the invention is not subject to any particular restrictions. One option comprises mixing the individual constituents by melting the plastics material and mixing in the relevant constituents. Production of the fibers is advantageously effected by the dry spinning process, though the wet spinning process may likewise be considered. In the dry spinning process, the plastics material, in particular cellulose ester, is dissolved, preferably in customary fashion, for example in acetone. The relevant further constituents, such as the transition-metal-modified titanium dioxide in particular, are then added to subsequently carry out the customary spinning procedure in a drying channel. Another embodiment of the dry spinning process provides for mixing the relevant further constituents—except the plastics material, in particular cellulose ester—such as in particular the transition-metal-modified titanium dioxide with a suitable solvent, for example acetone, and then adding the plastics material, in particular cellulose ester. This mixture is likewise then used for the customary spinning procedure in a drying channel.

Should the contents of any patents, patent applications and publications incorporated by reference in this application conflict with the contents of the present application in so far as the conflict renders unclear a definition in the present application then the present application is to be given precedence.

The invention is more particularly elucidated hereinbelow with the aid of examples.

### EXAMPLE 1

An iron-modified TiO2 produced as per example 2 of WO 2012/139726 is employed as per the process disclosed in example 1 of WO 2010/017989 in the production of a cellulose acetate-based filter rod. Compared to a filter rod produced with unmodified TiO2 the filter according to the invention exhibits improved degradability under environmental conditions.

1-15. (canceled)

16. A catalytically degradable plastics material comprising a catalytically active titanium dioxide modified by addition of at least one transition metal.

17. The catalytically degradable plastics material as claimed in claim 16, wherein the plastics material is a cellulose ester, cellulose propionate, cellulose butyrate, cellulose acetate propionate, cellulose acetate butyrate, or mixtures thereof.

18. The catalytically degradable plastics material as claimed in claim 17, wherein the cellulose ester has an average degree of substitution (DS) of 1.5 to 3.0.

19. The catalytically degradable plastics material as claimed in claim 17, wherein the cellulose ester has an average degree of polymerization of 150 to 500.

20. The catalytically degradable plastics material as claimed in claim 16, further comprising a finely dispersed non-transition-metal-modified titanium dioxide.

21. The catalytically degradable plastics material as claimed in claim 16, wherein the transition-metal-modified titanium dioxide is transition-metal-doped on its surface.

22. The catalytically degradable plastics material as claimed in claim 16, wherein the transition-metal-modified titanium dioxide has a crystallite size of 5 to 150 nm.

23. The catalytically degradable plastics material as claimed in claim 16, wherein the transition-metal-modified titanium dioxide has a density of 3.0 to 5.0 g/cm³, as determined by ISO 787, part 10.

24. The catalytically degradable plastics material as claimed in claim 16, wherein the (BET) specific surface area of the transition-metal-modified titanium dioxide is greater than 100 m²/g.

25. The catalytically degradable plastics material as claimed in claim 16, wherein the transition-metal-modified titanium dioxide has an enhanced light absorption in the range λ≧400 nm compared to pure titanium dioxide.

26. The catalytically degradable plastics material as claimed in claim 21, wherein the catalytically degradable plastics material comprises 0.1 to 5 wt % of transition-metal-doped titanium dioxide.

27. The catalytically degradable plastics material as claimed in claim 16, wherein the transition-metal-modified titanium dioxide has a transition metal content of from 0.05 to 5 wt %.

28. The catalytically degradable plastics material as claimed in claim 17 comprising at least 60 wt. % of the cellulose ester.

29. A molding, fiber, fibers, filter tow, film, films, deep drawn film, deep drawn films, packaging material or materials, injection-molded article or articles, thick-walled molding or moldings, pellets, beads, microbeads, and a vessel or vessels comprising the catalytically degradable plastics material as claimed in claim 16.

30. A cigarette filter comprising filter tow, wherein the filter tow comprises the catalytically degradable plastics material as claimed in claim 16.

31. The catalytically degradable plastics material as claimed in claim 16, wherein the material is photocatalytically degradable plastics material.

32. The catalytically degradable plastics material as claimed in claim 16, wherein the transition metal is iron.

33. The catalytically degradable plastics material as claimed in claim 17, wherein the cellulose ester is cellulose acetate.

34. The catalytically degradable plastics material as claimed in claim 16, wherein the transition-metal-modified titanium dioxide has a transition metal content of from 0.3 to 3 wt %.

35. A process for making a cigarette filter comprising filter plugs, wherein the filter plugs comprise filter tow comprising the catalytically degradable plastics material as claimed in claim 16.
